(19) United States
(12) Patent Application Publication
(10) Pub. No.: US 2017/0046490 A1
(43) Pub. Date: Feb. 16, 2017

(54) DENTAL SERVICES SYSTEM

(71) Applicant: Samuel W. Bollwinkel, Gilbert, AZ (US)

(72) Inventor: Samuel W. Bollwinkel, Gilbert, AZ (US)

(21) Appl. No.: 15/234,875

(22) Filed: Aug. 11, 2016

Related U.S. Application Data
(60) Provisional application No. 62/204,258, filed on Aug. 12, 2015.

(51) Int. Cl. G06F 19/00; G06F 17/30

(52) U.S. Cl. CPC G06F 19/327; G06F 17/30867; G06F 19/328; G06F 17/30312

(57) ABSTRACT

A dental services system is provided. The dental system operates to assess the needs of a walk-in patent in one of a plurality of facilities that are a part of the system. The system determines each facility's (1) proximate distance and associated drive time from the facility of the walk-in patient, (2) wait time for the specific procedure at all facilities in the system, (3) resources available at all facilities in the system, (4) patient rooms available at all facilities in the system, (5) staff on call at all facilities in the system, and (6) equipment offered at all facilities in the system.

### CROSS REFERENCE TO RELATED APPLICATION[S]

This application claims priority to U.S. Provisional Patent Application entitled “DENTAL SERVICES SYSTEM,” Ser. No. 62/204,258, filed Aug. 12, 2015, the disclosure of which is hereby incorporated entirely herein by reference.

### BACKGROUND OF THE INVENTION

Technical Field

This invention generally relates to an office management system and more particularly to a dental services system that tracks and coordinates resources at multiple dental services facilities that are remote from one another.

State of the Art

Patients in need of dental care have generally had to call their dentist, schedule an appointment, perhaps wait to be on a cancellation list for more urgent dental care, or spend valuable time calling around to different and often unknown dentists that can provide more immediate care. This process of finding a dentist and scheduling an appointment can be quite aggravating, burdensome, and an ineffective use of both patient and dental office staff time.

There is a need for a more efficient way of treating patients, saving precious time, and maintaining a repertoire with a network of continuing dental providers. In a society where immediacy is embraced, there is a shift toward a growing need for urgent care services; this shift exists both in general medical and specialized dental fields alike. It is not uncommon that would-be routine dental procedures may turn into immediate surgeries if not treated within a certain timeframe before the condition worsens. Furthermore, once a condition worsens, it can be considerably more costly and painful to treat. Also, patients frequently tend to prefer to stay within a single office and network of partnering dentists in order to avoid filling out additional paperwork, and to maintain the level of comfort with a cohesive partnership of dentists.

Additionally, most dental offices provide on-call dentists who may or may not be willing to treat a patient outside of the regularly scheduled business hours, dependent upon the patients' condition. The process of obtaining an on-call dentist can similarly cost a patient hours of searching and waiting around for the possibility of seeing a dentist over the weekend.

Accordingly, there is a need for an improved office management system that overcomes these issues.

### SUMMARY OF THE INVENTION

The present invention relates to a dental services system that operates to assess the needs of a walk-in patent in one of a plurality of facilities that are a part of the system, determine each facility's (1) proximate distance and associated drive time from the facility of the walk-in patient, (2) wait time for the specific procedure at all facilities in the system, (3) resources available at all facilities in the system, (4) patient rooms available at all facilities in the system, (5) staff on call at all facilities in the system, and (6) equipment offered at all facilities in the system.

An embodiment includes a dental services system comprising: a plurality of facility computers, each facility computer located at and associated with a single dental facility, wherein each facility computer stores dental data for the associated dental facility comprising a location of the associated dental facility, wait time for specific procedures, resources available, patient rooms available, scheduled appointments, staff on call, and equipment offered; and a central server coupled to the plurality of facility computers and programmed to: receive from each of the plurality of facility computers dental data comprising the location of the associated dental facility, the wait time for specific procedures, the resources available, the patient rooms available, the scheduled appointments, the staff on call, and the equipment offered; automatically store the dental data in a repository located on the server; receive from one of the plurality of facility computers a query comprising walk-in patient information, including initial determination of symptoms and condition; in response to receiving the query, automatically retrieve the stored dental data for the plurality of dental facilities; and using the dental data for the plurality of dental facilities, automatically generate and transmit to a display of the facility computer originating the query data: a) approximate distance and associated drive time from the facility of the walk-in patient to each of the other dental facilities of the plurality of dental facilities, b) a wait time for the specific procedure at each dental facility, c) resources available at each dental facility, d) patient rooms available at each dental facility, e) staff on call at each facility, and f) equipment offered at each dental facility.

Another embodiment includes a dental services system comprising: a first facility computer located at a first dental facility, wherein the first facility computer stores first dental data for the first dental facility comprising a location of the first dental facility, wait time for specific procedures, resources available, patient rooms available, scheduled appointments, staff on call, and equipment offered; a second facility computer located at a second dental facility, wherein the second facility computer stores second dental data for the second dental facility comprising a location of the second dental facility, wait time for specific procedures, resources available, patient rooms available, scheduled appointments, staff on call, and equipment offered; and a central server coupled to the first facility computer and the second facility computer, the central server programmed to: receive from the first facility computer the first dental data; automatically store the first dental data in a repository located on the server; receive from the second facility computer the second dental data; automatically store the second dental data in the repository located on the server; receive from the first facility computer a query comprising walk-in patient information, including initial determination of symptoms and condition; in response to receiving the query, automatically retrieve the stored first and second dental data for the first and second dental facilities; and using the first and second dental data for the first and second dental facilities, automatically generate and transmit to a display of the first facility computer: a) approximate distance and associated drive time from the first dental facility to the second dental facility, b) a wait time for the specific procedure at the first dental facility and the second dental facility, c) resources available at the first dental facility and the second dental facility, d) patient rooms available at the first dental facility and the second dental facility, e) staff on call at the first dental facility and the second dental facility, and f) equipment offered at the first dental facility and the second dental facility.

Yet, another embodiment includes a method of using a dental services system, the method comprising: assessing a patient's needs; entering patient data into system through a facility computer; generating all dental service options relating to the patient for all facilities that are a part of the system; and presenting the dental service options to the patient.

The foregoing and other features and advantages of the present invention will be apparent from the following more detailed description of the particular embodiments of the invention, as illustrated in the accompanying drawings.

### BRIEF DESCRIPTION OF THE DRAWING

A more complete understanding of the present invention may be derived by referring to the detailed description and claims when considered in connection with the Figures, wherein like reference numbers refer to similar items throughout the Figures, and:

FIG. 1 shows an embodiment of a dental services system; and

FIG. 2 depicts a flow chart of a method of using a dental services system.

### DETAILED DESCRIPTION OF THE INVENTION

A dental services system may be a computer operated system that may generally require computer software operating on a computer located in a dental facility and computer software operating on a central server, wherein there are a plurality of facilities in the system, the central server, a computer network for connecting the computers located in the dental facilities with the central server.

The dental services system saves time and energy by reducing the amount of work dental office staff must perform to research aforementioned availabilities within the network. Prior to the dental services system, when a patient walk-in occurred an employee would have to request that the patient fill-out a series of forms, meanwhile the employee would manually assess whether they have available staff, machines, rooms and resources. Thereafter, the employee would contact other facilities within a network to research their respective availabilities, if there was even another facility within the network. Next, the employee would provide general information about the other facility and the patient can then decide whether she would like to remain within the network of doctors located at the available facilities, or travel to an unrelated facility. In addition to the burdensome time it takes an employee to conduct the prior process of a patient walk-in, the employer wastes money paying an employee to process patient walk-in's in the prior manner. Hence, the dental services system is an effective system that assesses walk-in patient's needs; moreover, it saves employees time and employers money.

The system may operate such that when a walk-in patients needs are assessed, the software determines each facility's proximate distance and associated drive time from the other facilities in the network, wait time for the specific procedure, available resources, patient rooms available, staff on call, and equipment offered, within the network. Furthermore, the system may determine dentist-specific functions including dentist availability, experience, specialty procedures offered, and patient relationship history. The system similarly saves walk-in patient's time in order for a more enjoyable, convenient interaction with the dentist office employees. Akin to saving time, the dentist office and network saves money by an immediate solution to walk-in patient's needs, therefore potentially keeping existing and new walk-in patients within the network of dentists.

The system utilizes computer software that may include machine-readable instructions that is stored on a memory of the computer at the dental facility or the central server location and provides the instructions to the computer's processor to perform specific tasks and functions. A computer network comprises a plurality of computers and a central server in communication with one another through a network connection.

The dental services system processes information requests and delivers the requested information to end-users located at each respective facility location. Each facility tracks within the system all the resources located at the facility including documents, rooms, types of rooms, equipment, tools, staff, and procedures offered. The software may additionally transform functions of a global positioning system (“GPS”) to calculate drive times in addition to estimated wait times and balance the overall time estimations with wait times at the current facility at which the walk-in patient is located.

Providing dental patients with the (1) convenience of a walk-in location, (2) estimates for proximate distance and associated drive times to other facilities within the network, and (3) wait times at said facilities is invaluable. Not only would patients be able to achieve the prior listed benefits, but they also maintain peace of mind that they are keeping within the same network of doctors and they need not fill out any additional paperwork when arriving at an alternate facility. Moreover, said patients have the benefit of choosing for themselves which facility they travel to, and will know whether they expect to have any wait time when they arrive at the alternate facility.

Likewise, dentists are greatly benefited by the invention. The dental services system may determine dentist availability, experience, specialty procedures offered, and patient relationship history among other elements to consider with regard to dental services. By implementing these additional features, a network of doctors can assess which dentist is best suited for a patient's needs. Akin to the function of balancing dentist availability with patient's goals, the system also balances the hours dentists worked and the probability of specific walk-in procedures to forecast patient needs and availability at each facility. Thus, dentists benefit from the dental services system organizing and simplifying their schedules such that each doctor attends to a proportionate amount of patients—as the other doctors within the network—on a given day.

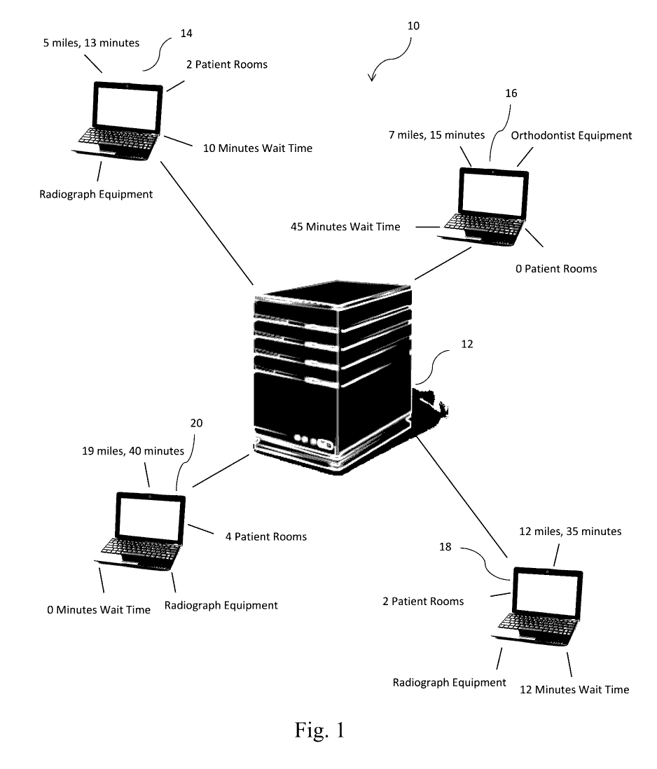

FIG. 1 schematically depicts an embodiment of a dental services system 10. The system 10 comprises a central server 12 and plurality of dental facility computers 14, 16, 18 and 20. Central server 12 and facility computers 14, 16, 18 and 20 form a computer network.

The central server 12 may be located at a location remote from the facility computers 14, 16, 18 and 20, may be located at any one of the plurality of dental facility locations, or an alternative location. The central server 12 and facility computers 14, 16, 18, 20 communicate with each other over a network connection. The network connection may be an internet connection, a WAN, a LAN, or any other type of communication connections that allows for transfer of information between the server 12 and the facility computers 14, 16, 18, 20.

In some embodiments, the facility computers 14, 16, 18, 20 communicate several forms of information and/or data in real-time with the central server 12, such as but not limited to, each facility's location, wait time for specific procedures, resources available, patient rooms available, scheduled appointments, staff on call, and equipment offered. The central server 12 stores the data from the facility computers 14, 16, 18, 20 in a database located on memory of the server 12 in response to a processor executing computer software stored in the memory of the server 12. The database is a repository of information that corresponds to each dental facility of the system 10. The database allows facility computers 14, 16, 18, 20 to access the information in the database through the network connection and analyze the data as it pertains to a walk-in patient. The facility computers 14, 16, 18, 20 may each access the central server 12 and send one or more queries to the central server 12. The server 12 may include computer software that processes the data sent in the queries and is programmed to perform operations to locate data in the database matching the queries and returning the data to the facility computers 14, 16, 18, 20. The computer software operating on the facility computers 14, 16, 18, 20 may then be executed and process the information and display the same on the display of the facility computers 14, 16, 18, 20. This information may then be presented to the patient to allow the patient to choose the desired course of action of either staying at the current facility or going to one of the facilities in the network based on the information provided by the system 10.

An example of the operation of system 10 includes reference to FIG. 1. For example, and without limitation, a dental facility may include facility computer 16. Facility computer 16 is in communication with central server 12 through a network connection. Facility computer operates to send information to central server 12, wherein the information includes, without limitation, the facility's location, scheduled appointments, wait time for specific procedures, resources available, patient rooms available, staff on call, and equipment offered. In some embodiments, the facility computer 16 may send any changes to the current status or data previously submitted and maintained in on the central server in order to provide real-time status of various characteristics and elements of the dental facility housing facility computer 16.

As a patient walks into dental facility having facility computer 16, an initial assessment is made with regard to the walk-in patient to determine the type of procedure that is likely needed to treat the patient. For example, the walk-in patient may be assessed as having an impacted wisdom tooth. A user of the system 10 may then access central server through facility computer 16 to enter one or more queries into the system 10. The software application operating on facility computer 16 prompt the user for information and automatically generate one or more queries that are automatically sent to the central server 12. The user inputs may include patient information, including any insurance information, initial determination of symptoms and condition, the types of dental specialists at the facility, and the like.

Upon receiving the query(ies) from the facility computer 16, the central server 12 then operates computer software stored on memory of the server 12 in order to access data stored in a database. The data stored on the database comprises information submitted to the central server from all facility computers 14, 15, 18 and 20. The central server 12 then processes the data and send information to the facility computer 16. Facility computer 16 may then process and display the information received from the central server. The information may include, without limitation, each facility's proximate distance and associated drive time from the facility of the walk-in patient, a wait time for the specific procedure at all facilities, resources available at all facilities, patient rooms available at all facilities, staff on call at all facilities, and equipment offered at all facilities in the system.

The user may then provide the system generated information to the walk-in patient and allow the walk-in patient to make a decision as to whether the patient will stay and wait. For example, the system may return the following information: Facility 116 may have a 45 minute wait and no resources available until after the wait; Facility 114 may be 5 miles away with an approximate travel time of 13 minutes, 2 patient rooms available, radiograph equipment available, a general dentist available and assistant staff and a 10 minute wait time; Facility 118 may be 12 miles away with an approximate travel time of 35 minutes, 2 patient rooms available, radiograph equipment available, a general dentist and endodontist available and assistant staff and a 12 minute wait time; and Facility 120 may be 19 miles away with an approximate travel time of 40 minutes, 4 patient rooms available, radiograph equipment available, a general dentist and an orthodontist available and assistant staff and a 0 minute wait time.

The walk-in patient then determines that she wishes to go to facility 114 because it will be the shortest time to see the dentist. The user at facility 116 may then enter information for the walk-in patient through the facility computer 16 and send the same to facility 114. This may be done through central server or may be communicated directly to facility computer 14 of facility 114. This can be utilized to shorten the time of entering information at facility 114 and to expedite service of the walk-in patient.

Upon reaching the facility 114, the facility computer 14 may then update the data in the database of the central server 12. That updated data may then be used by all facility computers 14, 16, 18, 20 in the system 10.

It will be understood that similar steps can be performed at any facility within the system 10. This provides more immediate and timely care to patients in need of urgent and emergency dental care.

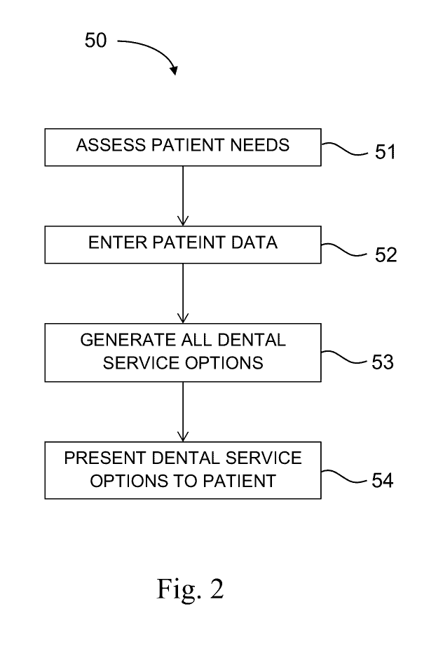

Referring to FIG. 2 of the drawings, additional embodiments of the present invention include a method 50 of using a dental services system. The method may include assessing a patient's needs (Step 51); entering patient data into system through a facility computer (Step 52); generating all dental service options relating to the patient for all facilities that are a part of the system (Step 53); and presenting the dental service options to the patient (Step 54).

The method 50 may include various other steps. For example Step 51 of assessing the patient's needs may include performing a triage analysis by a dental services professional. Step 52 of entering patient data may include generating a query to a server of the system to generate other possible dental service options. The query may be generated automatically by a software application operating on the facility computer. The method 50 may include sending the query automatically to a server of the system.

Step 53 of generating all dental service options may include automatically operating a software application stored and operated on the server in response to receiving a query, wherein the server processes data stored on the server in real time from all facility computers of the system and returns the data to the facility computer making the query.

The method may also include automatically transferring the entered patient data to a facility locate remote from the facility performing the initial assessment of the patient if the patient elects to go to the remote facility. The system may automatically assign a priority to the incoming patient from the original assessing facility.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A dental services system comprising:
a plurality of facility computers, each facility computer located at and associated with a single dental facility, wherein each facility computer stores dental data for the associated dental facility comprising a location of the associated dental facility, wait time for specific procedures, resources available, patient rooms available, scheduled appointments, staff on call, and equipment offered; and
a central server coupled to the plurality of facility computers and programmed to:
receive from each of the plurality of facility computers dental data comprising the location of the associated dental facility, the wait time for specific procedures, the resources available, the patient rooms available, the scheduled appointments, the staff on call, and the equipment offered;
automatically store the dental data in a repository located on the server;
receive from one of the plurality of facility computers a query comprising walk-in patient information, including initial determination of symptoms and condition;
in response to receiving the query, automatically retrieve the stored dental data for the plurality of dental facilities; and
using the dental data for the plurality of dental facilities, automatically generate and transmit to a display of the facility computer originating the query data: a) approximate distance and associated drive time from the facility of the walk-in patient to each of the other dental facilities of the plurality of dental facilities, b) a wait time for the specific procedure at each dental facility, c) resources available at each dental facility, d) patient rooms available at each dental facility, e) staff on call at each facility, and f) equipment offered at each dental facility.

2. The system of claim 1, wherein the central server is located remote from the plurality of dental facilities.

3. The system of claim 1, wherein the walk-in patient data includes age and gender of the patient.

4. The system of claim 1, wherein the walk-in patient data includes insurance information.

5. The system of claim 1, wherein the central server is further programmed to receive updated data from the plurality of facility computers when updated data is entered into one of the plurality of facility computers.

6. The system of claim 5, wherein the central server is further programmed to automatically store the updated data in the repository of the server.

7. The system of claim 1, wherein the central server is programmed to send walk-in patient data to the dental facility selected by the patient.

8. A dental services system comprising:
a first facility computer located at a first dental facility, wherein the first facility computer stores first dental data for the first dental facility comprising a location of the first dental facility, wait time for specific procedures, resources available, patient rooms available, scheduled appointments, staff on call, and equipment offered;
a second facility computer located at a second dental facility, wherein the second facility computer stores second dental data for the second dental facility comprising a location of the second dental facility, wait time for specific procedures, resources available, patient rooms available, scheduled appointments, staff on call, and equipment offered; and
a central server coupled to the first facility computer and the second facility computer, the central server programmed to:
receive from the first facility computer the first dental data;
automatically store the first dental data in a repository located on the server;
receive from the second facility computer the second dental data;
automatically store the second dental data in the repository located on the server;
receive from the first facility computer a query comprising walk-in patient information, including initial determination of symptoms and condition;
in response to receiving the query, automatically retrieve the stored first and second dental data for the first and second dental facilities; and
using the first and second dental data for the first and second dental facilities, automatically generate and transmit to a display of the first facility computer:
a) approximate distance and associated drive time from the first dental facility to the second dental facility, b) a wait time for the specific procedure at the first dental facility and the second dental facility, c) resources available at the first dental facility and the second dental facility, d) patient rooms available at the first dental facility and the second dental facility, e) staff on call at the first dental facility and the second dental facility, and f) equipment offered at the first dental facility and the second dental facility.

9. The system of claim 8, wherein the central server is located remote from the first and second dental facilities.

10. The system of claim 8, wherein the walk-in patient data includes age and gender of the patient.

11. The system of claim 8, wherein the walk-in patient data includes insurance information.

12. The system of claim 8, wherein the central server is further programmed to receive updated data from the first or second facility computers when updated data is entered into the first or second facility computers respectively.

13. The system of claim 12, wherein the central server is further programmed to automatically store the updated data in the repository of the server.

14. The system of claim 1, wherein the central server is programmed to send walk-in patient data to the second facility computer in response to the patient selecting to go to the second dental facility.

15. A method of using a dental services system, the method comprising:
assessing a patient's needs;
entering patient data into system through a facility computer;
generating all dental service options relating to the patient for all facilities that are a part of the system; and
presenting the dental service options to the patient.

16. The method of claim 15, wherein entering patient data includes automatically generating a query and sending the query to a server of the system, wherein the server generates other possible dental service options.

17. The method of claim 16, wherein generating other possible dental service options includes automatically operating a software application stored and operated on the server in response to receiving the query.

18. The method of claim 17, wherein the server processes data stored on the server from all facility computers of the system and returns the data to the facility computer making the query.

19. The method of claim 18, further comprising automatically transferring the entered patient data to a facility located remote from the facility performing the initial assessment of the patient in response to the patient electing to go to the remote facility.

20. The method of claim 19, further comprising automatically assigning a priority to the incoming patient from the original assessing facility.
